(19) United States
(12) Patent Application Publication
(10) Pub. No.: US 2025/0360823 A1
(43) Pub. Date: Nov. 27, 2025

(54) CHARGING APPARATUS FOR ELECTRIC VEHICLE

(71) Applicants: Hyundai Motor Company, Seoul (KR); Kia Corporation, Seoul (KR)

(72) Inventor: Tae Hwan KANG, Hwaseong-Si (KR)

(73) Assignees: Hyundai Motor Company, Seoul (KR); Kia Corporation, Seoul (KR)

(21) Appl. No.: 18/937,528

(22) Filed: Nov. 5, 2024

(30) Foreign Application Priority Data
May 24, 2024 (KR) 10-2024-0067845

(51) Int. Cl. B60L 53/31; B60L 53/16; B60L 53/18

(52) U.S. Cl. CPC B60L 53/31; B60L 53/16; B60L 53/18

(57) ABSTRACT

A charging apparatus includes an enclosure including an outlet hole at an upper portion of the enclosure, a rail provided in the enclosure, a roller unit provided to be movable along the rail, a wire including a first end portion connected to the roller unit, a spool unit to which a second end portion of the wire is connected, the spool unit rotatably driven to wind the wire, and a charging cable including a first end portion fixed to the inside of the enclosure and a second end portion including a charging gun, the charging cable extending to the outside of the enclosure through the outlet hole via the roller unit.

### CROSS-REFERENCE TO RELATED APPLICATION(S)

The present application claims priority to Korean Patent Application No. 10-2024-0067845filed on May 24, 2024, the entire contents of which is incorporated herein for all purposes by this reference.

### BACKGROUND OF THE PRESENT DISCLOSURE

### Field of the Present Disclosure

The present disclosure relates to a charging apparatus for an electric vehicle preventing a charging cable from coming into contact with the ground, even when the charging cable is maximally extended, preventing damage to the charging cable and making it convenient to use.

### Description of Related art

Electric vehicles, such as electric cars, electric trucks, and electric buses, obtain power from a battery to drive a motor to travel. A battery needs to be frequently charged, and a user may charge the battery using a public charging apparatus provided on a road or the like, or by use of a commercial power source at home.

A charging apparatus includes a charging cable including an end portion to which a charging gun is connected, and the charging gun includes a plug connector. With an increase in charging power, a thicker, heavier, and high-capacity cable have been used as the charging cable. The charging cable needs to include a sufficient length for connection to multiple vehicles having different charging plug positions, due to a position condition of the charging apparatus.

Such an increase in weight and length of the charging cable may cause the charging cable to come into contact with the ground during charging, which may frequently cause damage to an external sheath of the charging cable. A user may be inconvenienced by the need for excessive care in handling the charging cable connected to the charging gun. Furthermore, the charging apparatus may be subject to accidents such as electrical leakage due to damage to the charging cable.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a charging apparatus for an electric vehicle for preventing a charging cable from coming into contact with the ground even when the charging cable is maximally extended, preventing damage to the charging cable and making it convenient to use.

According to an aspect of the present disclosure, there is provided a charging apparatus including an enclosure including an outlet hole at an upper portion of the enclosure, a rail provided in the enclosure, a roller unit provided to be movable along the rail, a wire including a first end portion connected to the roller unit, a spool unit to which a second end portion of the wire is connected, the spool unit rotatably driven to wind the wire, and a charging cable including a first end portion fixed to the inside of the enclosure and a second end portion including a charging gun, the charging cable extending to the outside of the enclosure through the outlet hole via the roller unit.

The charging apparatus may further include a guide provided on the upper portion of the enclosure to guide movement of the charging cable in the guide. The guide may extend to a predetermined length to protrude toward one side of the enclosure.

The guide may include a pair of partition walls spaced apart from each other, and a base supporting the partition wall at a lower end portion of the partition wall. A swivel may be located between the enclosure and the base.

A drum may be mounted on a protruding end portion of the guide.

The rail may include a guide groove formed to extend in a longitudinal direction of the rail. Flanges, protruding toward each other, may be formed at opposite open end portions of the guide groove, and a predetermined gap is formed between the opposite flanges.

The roller unit may include a rotation shaft, a first roller mounted on one side of the rotation shaft, the first roller inserted into the guide groove, and a second roller mounted on the other side of the rotation shaft, the second roller around which the charging cable is wound. The rotation shaft may be positioned in the gap.

The roller unit may further include a weight. The weight may be connected to the rotation shaft or the wire.

The spool unit may include a fixed shaft fixed to the inside of the enclosure, a spool body rotatably mounted on the fixed shaft, and an elastic member located between and connected to the fixed shaft and the spool body. When external force is released, the spool body of the spool unit may rotate in a winding direction due to elastic support force of the elastic member to wind the wire so that the roller unit may return to an original position of thereof along with the charging cable.

The spool unit may include a motor provided in the enclosure, and a spool body connected to the motor to be rotatable by the motor. When external force is released, the spool body of the spool unit may rotate in a winding direction according to driving of the motor to wind the wire so that the roller unit may return to an original position of thereof along with the charging cable.

The charging apparatus may include a first sensor disposed in the charging gun to detect separation between a connector of the charging gun and a charging plug, a second sensor provided in the enclosure to detect a position of the charging cable or the roller unit, and a controller electrically connected to the first sensor, the second sensor, and the motor to control and regulate an operation of the motor.

The first sensor may detect separation between the connector of the charging gun and the charging plug and may transmit a detection signal to the controller, and the controller may be configured for controlling application of power to operate the motor. The second sensor may detect return of the charging cable or the roller unit and may transmit a detection signal to the controller, and the controller may stop an operation of the spool unit.

The charging gun may be stored in a holding groove or a holder provided on one external surface of the enclosure.

According to example embodiments of the present disclosure, even when a charging cable is maximally extended, balance of the charging cable may be maintained to allow the charging cable to not come into contact with a road surface, preventing damage to the charging cable and preventing safety accidents in advance.

Furthermore, according to example embodiments of the present disclosure, the charging cable may be configured to be pulled out to a sufficient length from an upper end portion of a charging apparatus, reducing a load of the charging cable, experienced by a user, and enabling connection to multiple vehicles having different charging plug positions to increase convenience of the user.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a diagram illustrating a charging apparatus according to a first exemplary embodiment of the present disclosure.

FIG. 2 is a diagram illustrating an operating state of a charging apparatus according to the first exemplary embodiment of the present disclosure.

FIG. 3 is a diagram illustrating a charging apparatus according to a second exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

As used herein, a vehicle refers to various vehicles transporting a transported object such as a person, animal, or object from a starting point to a destination. Such vehicles are not limited to vehicles travelling on roads or tracks.

Terms such as first, second, A, B, (a), (b), and the like may be used herein to describe components. Each of these terminologies is not used to define an essence, order, size, location, or importance of a corresponding component but used merely to distinguish the corresponding component from other component(s).

Hereinafter, the present disclosure will be described in detail with reference to exemplary drawings. In adding reference numerals to components of each drawing, it should be noted that the same components are indicated by the same numerals even though displayed on different drawings.

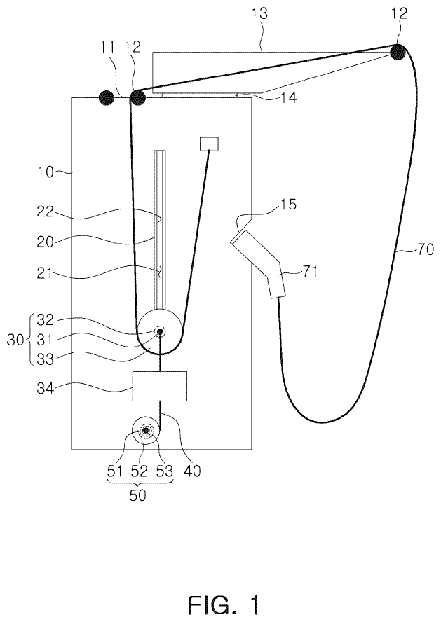

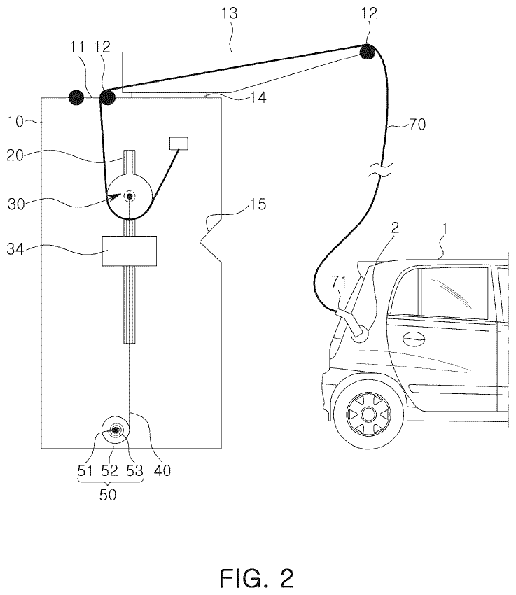

FIG. 1 is a diagram illustrating a charging apparatus according to a first exemplary embodiment of the present disclosure. FIG. 2 is a diagram illustrating an operating state of the charging apparatus according to the first exemplary embodiment of the present disclosure.

A charging apparatus according to a first exemplary embodiment of the present disclosure may include an enclosure 10, a rail 20, a roller unit 30, a wire 40, a spool unit 50, and a charging cable 70.

The enclosure 10 may be a member that forms the exterior of the charging apparatus, and may include an approximately hexahedral shape, and may be formed of a sturdy material such as metal or plastic. However, a shape and material of the enclosure are not limited to the examples described above.

The enclosure 10 may accommodate a charging body therein. The charging body may include a converter, a breaker, a switch, a sensor, a controller, or the like.

The charging body may be connected to an external power grid to provide power received from the power grid to an electric vehicle. The external power grid may be various power sources, such as AC power from a three-phase system or DC power from any generator.

The charging body may include a converter to convert power supplied from the power grid. For example, the charging body may include a DC/DC converter for adjusting a level of DC power, or an AC/DC converter for rectifying AC power from a three-phase system and converting the AC power to DC power. As a result, the charging body may charge a battery of the electric vehicle using the converted DC power.

Furthermore, the charging body may include a breaker for reasons such as safety issues, and may include a switch controlling whether to supply power, and a sensor detecting whether the electric vehicle is connected, measuring an amount of charge, and monitoring overload.

The charging body may include a controller, controlling overall operations of the charging apparatus. The controller may be electrically connected to the converter, the breaker, the switch, the sensor, and the like, and may convert power supplied from the power grid into power including a form which may charge the electric vehicle, and may be configured for controlling supply of the converted power to the electric vehicle.

The enclosure 10 may include a user interface on one external surface thereof. The user interface may be electrically connected to the controller, and may receive an instruction from the user and display a charging result to the user while interacting with the user with respect to a process of initiating charging, paying for charging, and charging.

The charging body and the user interface are already known technologies, and thus detailed descriptions of configurations and operational relationships thereof will be omitted herein.

One end portion of the charging cable 70 may be fixedly disposed in the enclosure 10, and the charging cable may be electrically connected to the charging body. The charging cable may pass through the enclosure and extend from the inside of the enclosure to the outside of the enclosure.

To the present end, an upper portion of the enclosure may include an outlet hole 11 through which the charging cable 70 is pulled out. The outlet hole may be formed in the upper portion of the enclosure, but the present disclosure is not necessarily limited thereto.

A drum 12 may be mounted on at least one edge portion of the outlet hole 11 to allow the charging cable 70 to smoothly move slidably. The drum may not need to rotate. However, when the drum rotates, there is an advantage in that friction between the charging cable and the drum may be almost eliminated.

In an exemplary embodiment of the present disclosure, the drum 12 may be mounted in pair on at least one edge portion of the outlet hole 11 and the charging cable 70 may be mounted between the pair of the drums 12.

As described, due to the outlet hole 11 formed in the upper portion of the enclosure 10, the charging cable 70 may be pulled out from the upper portion of the enclosure. Accordingly, even when the charging cable is maximally extended, the charging cable may be prevented from coming into contact with the ground. As a result, damage to the charging cable may be prevented.

In an exemplary embodiment of the present disclosure, a guide 13 may be provided on the upper portion of the enclosure 10 to guide movement of the charging cable 70 in the guide and prevent the charging cable 70 from sagging. The guide 13 may be disposed to be adjacent to the outlet hole 11 of the enclosure. The guide may extend from the enclosure to a predetermined length to protrude toward one side of the enclosure 10, among a front side, a rear side, a left side, and a right side of the enclosure.

For example, the guide 13 may include a pair of partition walls that stand upright on an upper surface of the enclosure and are spaced apart from each other, and may be formed in a form of a channel, but a configuration of the guide is not necessarily limited thereto. As an exemplary embodiment of the present disclosure, an upper end portion of the partition wall may further include an upper plate so that the guide may be formed in a form of a duct, or the guide may be formed in a form of a hexahedral frame instead of the partition wall.

Furthermore, when the guide 13 include a pair of partition walls spaced apart from each other, a lower end portion of the guide 13 may further include a base, supporting the partition wall, and a swivel 14 may be located between the upper surface of the enclosure 10 and the base. Accordingly, the guide may be turned in a target direction thereof.

The drum 12 may be additionally mounted on an end portion of the guide 13 protruding from the enclosure 10 to allow the charging cable 70 to smoothly move slidably. The drum may not need to rotate. However, when the drum rotates, there is an advantage in that friction between the charging cable and the drum may be almost eliminated.

The charging cable 70, pulled out from the enclosure 10 through the outlet hole 11, may pass through the guide 13 and may then extend downwardly from an end portion of the guide due to an own weight thereof.

The rail 20 may be provided to be upright in the enclosure 10 to extend, for example, in a height direction of the enclosure. The rail 20 may be made of a sturdy material such as metal or plastic.

The rail 20 may include a guide groove 21 formed to extend in a longitudinal direction of the rail. In the guide groove, flanges 22, protruding toward each other, may be formed at opposite open end portions extending in the longitudinal direction of the rail, maintaining a predetermined gap between the flanges.

This rail 20 is configured to guide movement of the roller unit 30.

The roller unit 30 may partially inserted into the rail 20, that is, into the guide groove 21, and may slidably move in a reciprocating manner in the longitudinal direction of the rail. The roller unit 30 may include a rotation shaft 31, a first roller 32 mounted on one side of the rotation shaft, the first roller 32 inserted into the guide groove of the rail, and a second roller 33 mounted on the other side of the rotation shaft, the second roller 33 around which the charging cable 70 is wound.

The rotation shaft 31 may have a diameter or thickness less than or equal to that of the gap between the opposite flanges 22 provided in the guide groove 21 of the rail 20, and may be positioned in the gap. The rotation shaft and the first roller 32 may rotate relative to each other, but the present disclosure is not necessarily limited thereto. Similarly, the rotation shaft 31 and the second roller 33 may rotate relative to each other, but the present disclosure is not necessarily limited thereto.

The first roller 32 may have a diameter corresponding to a width of the guide groove 21. In other words, the diameter of the first roller 32 may be greater than the diameter of the rotation shaft 31. As a result, the first roller 32 may move in a rolling motion in the guide groove in a state of coming into contact with an internal wall of the guide groove 21, and the roller unit 30 may be smoothly raised and lowered along the rail 20. The diameter of the first roller may be less than a diameter of the second roller 33, but the present disclosure is not necessarily limited thereto.

The second roller 33 may rotate in a state of being partially in contact with the charging cable 70. In an exemplary embodiment of the present disclosure, the second roller 33 may include a roller groove formed to be radially inwardly concave along a circumferential surface thereof. A cross-section of the roller groove may have an approximately V-shape or U-shape. Accordingly, the charging cable 70 may be accommodated (or accommodated to be in close contact) in the roller groove of the second roller, stably maintaining contact with the second roller without being separated from the second roller 33.

When the charging cable 70 is pulled out from the enclosure 10 by external force and accordingly raised in the enclosure 10, the second roller 33 may be raised along with the charging cable 70 while rotating. Accordingly, the roller unit 30 may be raised according to guidance of the rail 20. In the instant case, the first roller 32 may upwardly move in a rolling motion in the guide groove 21 of the rail 20.

When the external force is released and the charging cable 70 is drawn into the enclosure 10 and accordingly is lowered, the second roller 33 may be lowered along with the charging cable while rotating. Accordingly, the roller unit 30 may be lowered according to guidance of the rail 20. In the instant case, the first roller 32 may downwardly move in a rolling motion in the guide groove 21 of the rail.

A configuration of the roller unit 30 is not necessarily limited to the examples described above and illustrated. For example, the roller unit 30 may include a cart which is movable while being accommodated in the guide groove 21, instead of the single first roller 32. In the instant case, in the cart, a plurality of first rollers, moving in a rolling motion in a guide groove, and a rotation shaft 31, supporting a second roller 33, may be provided, and the second roller may be configured to rotate relative to the rotation shaft.

In an exemplary embodiment of the present disclosure, to maintain balance by applying tension to the charging cable to prevent the charging cable from coming into contact with the ground when the charging cable 70 is pulled out from the enclosure 10, and to return the charging cable to an original position of thereof when the external force is released, the second roller 33 may be formed of a heavy material. Here, the heavy material may include, for example, heavy metal including a high specific gravity such as iron, copper, lead, tungsten, or the like. As a result, the second roller is configured as a weight roller.

Furthermore, to supplement a load of the second roller 33 or the roller unit 30, a weight 34 may be added to the roller unit 30. The weight 34 may be connected to the rotation shaft 31 via a connection member such as a rope or chain, or may be connected to the wire 40 between the roller unit 30 and the spool unit 50.

One end portion of the wire 40 may be connected to the roller unit 30, and the other end portion of the wire 40 may be connected to the spool unit 50 so that the wire 40 may be wound around the spool unit 50. At least one end portion of the wire may be fixed to the rotation shaft 31 of the roller unit. As a result, the wire can may be unwound from the spool unit or wound around the spool unit according to movement of the roller unit.

The spool unit 50 may be configured to wind the wire 40, and may be provided in the enclosure 10. The spool unit of the charging apparatus according to the first exemplary embodiment of the present disclosure may include a fixed shaft 51 fixed to the inside of the enclosure, a spool body 52 rotatably mounted on the fixed shaft 51, and an elastic member 53 located between the fixed shaft 51 and the spool body 52.

Here, a spiral spring may be used as the elastic member 53, but the present disclosure is not necessarily limited thereto.

When the charging cable 70 is raised while being pulled out from the enclosure 10 by external force, the second roller 33 may be raised along with the charging cable while rotating. As the roller unit 30 is raised, the wire 40 may be unwound from the spool unit 50. Accordingly, as the spool body 52 rotates, elastic support force may be accumulated in the elastic member 53.

Thereafter, when the external force is released, the spool body 52 may rotate in a winding direction due to the elastic support force of the elastic member 53 to wind the wire 40. As a result, the wire may pull the rotation shaft 31 of the roller unit 30 downwardly, causing the roller unit 30 to be lowered. As the roller unit 30 is lowered, the charging cable 70 may be drawn into the enclosure 10 and return to an original position thereof.

As described above, one end portion of the charging cable 70 may be fixedly disposed in the enclosure 10, and may be electrically connected to the charging body. The charging cable 70 may extend from the inside of the enclosure to the outside of the enclosure via the roller unit 30, in other words, by winding around the second roller 33 and passing through the enclosure through the outlet hole 11.

Furthermore, when the guide 13 is provided, the charging cable 70 pulled out from the outlet hole 11 may pass through the guide 13, and may then extend downwardly from an end portion of the guide 13 due to an own weight.

The other end portion of the charging cable 70 may include a charging gun 71, and the charging gun may include a plug connector connectable to a charging plug 2 of an electric vehicle 1. The charging gun may be stored in a holding groove 15 or a holder provided on one external surface of the enclosure, for example, one external surface including a user interface.

Accordingly, the charging apparatus of the present disclosure may be electrically connected to a battery of the electric vehicle 1 via the charging cable 70 to provide power supplied and converted from a power grid to the battery and charge the battery.

Hereinafter, an operation of the charging apparatus according to the first exemplary embodiment of the present disclosure will be described.

First, when a user who intends to charge the electric vehicle 1 moves the charging gun 71 from the holding groove 15 or the holder of the enclosure 10 toward the charging plug 2 of the electric vehicle, the charging cable 70 may be pulled out from the enclosure and moved toward the electric vehicle according to movement of the charging gun.

When the charging cable 70 begins to be pulled out by pulling force of the user, that is, external force, the charging cable may be raised in the enclosure 10, and the second roller of the roller unit 30 may be raised along the rail 20 with the charging cable while rotating. As a result, the roller unit may be raised in proportion to a length of the pulled-out charging cable according to guidance of the rail 20. In the instant case, the first roller 32 of the roller unit may upwardly move in a rolling motion in the guide groove 21 of the rail.

When the guide 13 is provided, the charging cable 70 pulled out from the outlet hole 11 may pass through the guide 13, and may then extend downwardly from an end portion of the guide 13 due to an own weight thereof. Here, when a partial weight of the charging cable 70, extending downwardly from the end portion of the guide, and the pulling force of the user are greater than a sum of a remaining weight of the charging cable accommodated in the enclosure 10, a weight of the roller unit 30 (optionally along with the weight 34) and elastic support force of the elastic member 53, the charging cable may be pulled out from the enclosure while maintaining balance.

As the length of the pulled-out charging cable 70 increases, the pulling force of the user may be reduced. The user may pull out the charging cable downwardly with gradually smaller force to move the charging gun 71 to be closer to the charging plug 2 of the electric vehicle 1, reducing a load of the charging cable, experienced by the user, and enabling connection to multiple vehicles including different charging plug positions.

When the charging cable 70 is fully extended, the roller unit 30 may be maximally raised. For example, when the guide 13 has a protruding length of 0.5 m, the charging cable extending downwardly from the end portion of the guide in an initial state has an extension length of 3.5 m, and the charging cable pulled out from the enclosure 10 has a pull-out length of 2 m, the charging gun 71 may reach within a radius of up to 6 meters from the enclosure.

Accordingly, in the charging apparatus according to the first exemplary embodiment of the present disclosure, even when the charging cable 70 is maximally extended, the charging cable 70 may be pulled out from an upper portion of the enclosure 10, and load balance may be maintained, preventing the charging cable from coming into contact with the ground.

When a connector of the charging gun 71 is connected to the charging plug 2 of the electric vehicle 1 and the user stops pulling, the charging cable 70 may be fixed by coupling force between the charging gun and the charging plug.

Subsequently, when charging of the electric vehicle 1 is completed and the user separates the charging gun 71 from the charging plug 2 and moves the charging gun 71 to the holding groove 15 or the holder of the enclosure 10, the external force may be released. That is, no pulling force from the user may exist. Thus, the charging cable 70 may be drawn back into the enclosure.

The spool body 52 may rotate in a winding direction by the elastic support force of the elastic member 53 to wind the wire 40. Accordingly, the wire may downwardly pull the rotation shaft 31 of the roller unit 30, and the roller unit may be lowered along with the charging cable 70 according to guidance of the rail 20. In the instant case, the first roller 32 of the roller unit rolls may downwardly move in a rolling motion in the guide groove 21 of the rail.

As the roller unit 30 is lowered, the charging cable 70 may be drawn into the enclosure 10 and accordingly lowered in the enclosure. Only a partial weight of the charging cable, extending downwardly from the end portion of the guide 13, may not overcome a sum of a remaining weight of the charging cable accommodated in the enclosure, a weight of the roller unit 30 (and the weight 34) and elastic support force of the elastic member 53. As a result, the charging cable may return to an original position thereof.

When the elastic support force of the elastic member 53 is released and rotation of the spool body 52 stops, the charging cable 70 may also reach the original position, and the charging apparatus may be in an initial state thereof before the charging gun 71 is used.

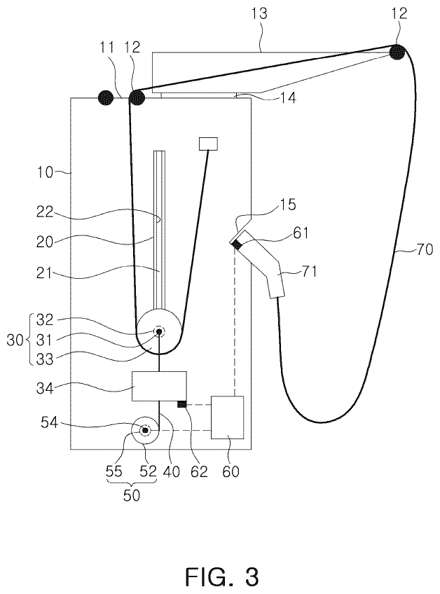

FIG. 3 is a diagram illustrating a charging apparatus according to a second exemplary embodiment of the present disclosure.

A charging apparatus according to a second exemplary embodiment of the present disclosure may include an enclosure 10, a rail 20, a roller unit 30, a wire 40, a spool unit 50, and a charging cable 70.

The charging apparatus according to the second exemplary embodiment of the present disclosure may be different from the charging apparatus according to the first exemplary embodiment in terms of a configuration of a spool unit 50 and addition of a controller 60, and may remaining components the same as the above-described components in the first exemplary embodiment of the present disclosure. Accordingly, in describing the charging apparatus according to the second exemplary embodiment of the present disclosure, detailed descriptions of configurations and operations of the components same as those of the charging apparatus according to the above-described first exemplary embodiment will be omitted.

The spool unit 50 may be configured to wind a wire 40, and may be provided in an enclosure 10. The spool unit of the charging apparatus according to the second exemplary embodiment of the present disclosure may include a motor 55 provided in the enclosure, and a spool body 52 disposed to be rotatable by the motor.

Here, the spool body 52 may be directly connected to a motor shaft 54 of the motor 55, or may be indirectly connected to the motor shaft 54 through a power transmission mechanism such as a gear.

The motor 55 may be connected to an external power grid by a wire, or may be connected to a battery additionally disposed in the enclosure 10 to receive power. The motor may rotate in one direction when power is applied.

Furthermore, the charging apparatus according to the second exemplary embodiment of the present disclosure may include a first sensor 61 disposed in a connector of a charging gun 71 to detect separation of the connector, a second sensor 62 provided in the enclosure 10 to detect a position of a charging cable 70 or a roller unit 30, and a controller 60 electrically connected to the first sensor, the second sensor, and the motor 55 to control and regulate an operation of the motor.

The first sensor 61 and the second sensor 62 may be a contact-type sensor configured for accurately detecting physical contact and separation, but the present disclosure is not necessarily limited thereto, and may be a non-contact-type sensor such as an optical sensor using an infrared ray or a laser, a capacitive sensor, a microwave sensor, or an ultrasonic sensor.

The first sensor 61 may detect separation between the connector of the charging gun 71 and a charging plug 2 (see FIG. 2) of an electric vehicle 1 (see FIG. 2), when charging is completed after the connector is connected to the charging plug. The second sensor 62 may be provided in the enclosure 10, and may detect the charging cable 70 or the roller unit 30 (optionally the weight 34) being raised and then lowered, and returning to an original position thereof.

The controller 60 may be electrically connected to the first sensor 61, the second sensor 62, and the motor 55 to communicate with the first sensor 61, the second sensor 62, and the motor 55 in a wired manner, in a wireless manner, or in a wired and wireless manner. The controller may be configured to control, based on a detection signal input from the first sensor, power to be applied to the motor for an operation of the motor, and may regulate, based on the detection signal input from the second sensor, an operation of the motor, that is, application of power.

As a result, the controller 60 may allow the wire 40 to be wound around the spool body 52 when a predetermined condition (connection and then separation of the connector) is satisfied, and then may stop an operation of the spool unit 50 when winding of the wire is completed.

The controller 60 may be implemented with a microprocessor, a memory, and the like, and may be merged into or used in conjunction with a controller configured for controlling overall operations of the charging apparatus.

When the charging cable 70 is pulled out from the enclosure 10 by external force and accordingly raised, the second roller 33 of the roller unit 30 may be raised along with the charging cable while rotating. As the roller unit 30 is raised, the wire 40 may be unwound from the spool body 52 of the spool unit 50. In the instant case, the motor 55 may be in an unpowered state by the controller so that the motor shaft may rotate freely according to rotation of the spool body.

After charging is completed, when the first sensor 61 detects separation between the connector of the charging gun 71 and the charging plug 2 of the electric vehicle 1 and transmits a detection signal to the controller 60, the controller may be configured for controlling application of power to operate the motor 55. According to driving of the motor, the spool body 52 may rotate in a winding direction to wind the wire 40.

Accordingly, the wire 40 may downwardly pull the rotation shaft 31 of the roller unit 30, causing the roller unit to be lowered. As the roller unit is lowered, the charging cable 70 may be drawn into the enclosure 10 and lowered to an original position thereof.

When the charging cable 70 is lowered and the second sensor 62 detects return of the charging cable or the roller unit 30 (or the weight 34) and transmits a detection signal to the controller 60, the controller may stop operation of the spool unit 50 including the motor 55 and the spool body 52.

Hereinafter, an operation of the charging apparatus according to the second exemplary embodiment of the present disclosure will be described.

Here, a process in which the charging cable 70 begins to be pulled out by pulling force of a user, that is, external force, and the connector of the charging gun 71 is connected to the charging plug 2 of the electric vehicle 1 so that the charging cable is fixed by coupling force between the charging gun and charging plug, may be the same as that described in the first exemplary embodiment of the present disclosure.

When charging of the electric vehicle 1 is completed and the user separates the charging gun 71 from the charging plug 2 and moves the charging gun 71 to a holding groove 15 or a holder of the enclosure 10, the external force may be released. That is, no pulling force from the user may exist. Thus, the charging cable 70 may be drawn back into the enclosure.

After charging is completed, when the first sensor 61 detects separation between the connector of the charging gun 71 and the charging plug 2 of the electric vehicle 1 by the user, the controller may be configured for controlling application of power to operate the motor 55. According to driving of the motor 55, the spool body 52 may rotate in a winding direction to wind the wire 40.

Accordingly, the wire 40 may downwardly pull the rotation shaft 31 of the roller unit 30, and the roller unit may be lowered along with the charging cable 70 according to guidance of the rail 20.

As the roller unit 30 is lowered, the charging cable 70 may be drawn into the enclosure 10 and accordingly lowered in the enclosure. Only a partial weight of the charging cable, extending downwardly from the end portion of the guide 13, may not overcome a sum of a remaining weight of the charging cable accommodated in the enclosure, a weight of the roller unit 30 (optionally along with the weight 34) and driving force of the motor 55. As a result, the charging cable may return to an original position thereof.

When the charging cable 70 is lowered and the second sensor 62 detects return of the charging cable or the roller unit 30 (or the weight 34), the controller 60 may stop an operation of the spool unit 50 including the motor 55 and the spool body 52. As a result, the charging apparatus may be in an initial state thereof before the charging gun 71 is used.

As described above, according to example embodiments of the present disclosure, even when a charging cable is maximally extended, balance of the charging cable may be maintained to allow the charging cable to not come into contact with a road surface, preventing damage to the charging cable and preventing safety accidents in advance.

Furthermore, according to example embodiments of the present disclosure, the charging cable may be configured to be pulled out to a sufficient length from an upper end portion of a charging apparatus, reducing a load of the charging cable, experienced by a user, and enabling connection to multiple vehicles including different charging plug positions to increase convenience of the user.

While example embodiments have been illustrated and described above, it will be apparent to those skilled in the art that modifications and variations could be made without departing from the scope of the present disclosure as defined by the appended claims.

For example, the above-described and illustrated example embodiments of the present disclosure may be combined with each other, and various exemplary embodiments of the present disclosure may optionally further employ or replace some components of other exemplary embodiments of the present disclosure, as necessary.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A charging apparatus comprising:
an enclosure including an outlet hole at an upper portion of the enclosure;
a rail provided in the enclosure;
a roller unit engaged to the rail and movable along the rail;
a wire including a first end portion connected to the roller unit;
a spool unit to which a second end portion of the wire is connected, the spool unit rotatably driven to selectively wind the wire; and
a charging cable including a first end portion fixed to an inside of the enclosure and a second end portion including a charging gun, the charging cable extending to an outside of the enclosure through the outlet hole via the roller unit.

2. The charging apparatus of claim 1, further including:
a guide provided on the upper portion of the enclosure to guide movement of the charging cable in the guide,
wherein the guide extends to a predetermined length to protrude toward one side of the enclosure.

3. The charging apparatus of claim 2, wherein the guide includes:
a pair of partition walls spaced apart from each other; and
a base supporting the partition wall at a lower end portion of the partition wall.

4. The charging apparatus of claim 3, wherein a swivel is mounted between the enclosure and the base.

5. The charging apparatus of claim 2, wherein a drum is mounted on a protruding end portion of the guide.

6. The charging apparatus of claim 2, wherein a drum is mounted on at least one edge portion of the outlet hole.

7. The charging apparatus of claim 6, wherein the drum is mounted in pair on the at least one edge portion of the outlet hole and the charging cable is mounted between the pair of the drums.

8. The charging apparatus of claim 1,
wherein the rail includes a guide groove formed to extend in a longitudinal direction of the rail, and
wherein flanges, protruding toward each other, are formed at opposite open end portions of the guide groove, and a predetermined gap is formed between the flanges.

9. The charging apparatus of claim 8,
wherein the roller unit includes:
a rotation shaft;
a first roller mounted on a first side of the rotation shaft, the first roller inserted into the guide groove; and
a second roller mounted on a second side of the rotation shaft, wherein the charging cable is wound around the second roller, and
wherein the rotation shaft is positioned in the predetermined gap.

10. The charging apparatus of claim 9,
wherein the roller unit further includes a weight, and
wherein the weight is connected to the rotation shaft or the wire.

11. The charging apparatus of claim 1, wherein the spool unit includes:
a fixed shaft fixed to the inside of the enclosure;
a spool body rotatably mounted on the fixed shaft; and
an elastic member located between and connected to the fixed shaft and the spool body, and
in response that external force is released, the spool body of the spool unit rotates in a winding direction due to elastic support force of the elastic member to wind the wire so that the roller unit returns to an original position of thereof along with the charging cable.

12. The charging apparatus of claim 1, wherein the spool unit includes:
a motor provided in the enclosure; and
a spool body connected to the motor to be rotatable by the motor, and
in response that external force is released, the spool body of the spool unit rotates in a winding direction according to driving of the motor to wind the wire so that the roller unit returns to an original position of thereof along with the charging cable.

13. The charging apparatus of claim 12, including:
a first sensor disposed in the charging gun to detect separation between a connector of the charging gun and a charging plug;
a second sensor provided in the enclosure to detect a position of the charging cable or the roller unit; and
a controller electrically connected to the first sensor, the second sensor, and the motor to control and regulate an operation of the motor.

14. The charging apparatus of claim 13,
wherein the first sensor is configured to detect the separation between the connector of the charging gun and the charging plug and to transmit a detection signal to the controller, and the controller is configured to control application of power to operate the motor according to the detection signal of the first sensor.

15. The charging apparatus of claim 13,
wherein the second sensor is configured to detect return of the charging cable or the roller unit and to transmit a detection signal to the controller, and the controller is configured to control application of power to the motor to stop an operation of the spool unit according to the detection signal of the second sensor.

16. The charging apparatus of claim 1, wherein the charging gun is stored in a holding groove or a holder provided on an external surface of the enclosure.
